(19) United States
(12) Patent Application Publication
(10) Pub. No.: US 2014/0243437 A1
(43) Pub. Date: Aug. 28, 2014

(54) Paint Composition For Forming Three-Dimensional Film

(71) Applicant: Eun Sung Lee, Seoul (KR)

(72) Inventor: Eun Sung Lee, Seoul (KR)

(21) Appl. No.: 13/963,618

(22) Filed: Aug. 9, 2013

(30) Foreign Application Priority Data
Feb. 28, 2013 (KR) 10-2013-0022384

(51) Int. Cl. C09D 7/12

(52) U.S. Cl. CPC C09D 7/1291
USPC 521/54

(57) ABSTRACT

A paint composition for forming a three-dimensional film including 1 to 10 wt % of a polymer hollow microsphere and 5 to 40 wt % of a polymer resin based on a total weight of the composition, wherein the polymer hollow microsphere has a density of 10 to 100 kg/m³ and a particle size of 10 to 200 μm.

### FIELD OF THE INVENTION

Disclosed herein is a paint composition for forming a three-dimensional film, and more specifically, is a paint composition for forming a three-dimensional film, which comprises a polymer hollow microsphere having a certain density and size and does not need a separate foaming process.

### BACKGROUND OF THE INVENTION

Most of conventional paints for craft are products embodying a three-dimensional shape by foaming pictures and letters, by expressing the desired pictures and letters in various materials followed by heating thereof using a device such as a microwave oven or a dryer. These craft paint is processed by a process comprising a separate heating process, for example using a dryer, and therefore, there is a defect that children as a major user are exposed to danger and it should be gone through a cumbersome process.

Accordingly, in order to remove such danger, there is a need for a paint, which can give a three-dimensional effect like foaming after painting or using letters without a separate foaming process.

### REFERENCES OF THE RELATED ART

### Patent Document

Korean Patent Publication No. 10-2007-0107824

### SUMMARY OF THE INVENTION

This disclosure is directed to providing a paint composition for forming a three-dimensional film, which has a three-dimensional effect by drying the desired pictures and letters on the surfaces of various materials expressed using the paint composition for forming a three-dimensional film without a separate foaming process such as heating

In an aspect, there is provided a paint composition for forming a three-dimensional film comprising 1 to 10 wt % of a polymer hollow microsphere and 5 to 40 wt % of a polymer resin based on a total weight of the composition, wherein the polymer hollow microsphere has a density of 10 to 100 kg/m³ and a particle size of 10 to 200 μm.

In an embodiment of the present disclosure, the polymer hollow microsphere may be gone through a foaming process.

In an embodiment of the present disclosure, the polymer hollow microsphere may be mixed with at least one selected from a group consisting of silica, calcium carbonate and talc.

In an embodiment of the present disclosure, the polymer resin may be at least one selected from a group consisting of polyvinyl pyrrolidone, polyvinyl alcohol, starch, polyvinyl acetate, styrene-acryl polymer, polyacrylate, vinyl acetate-acryl polymer and polyurethane.

In an embodiment of the present disclosure, the polymer resin may be a mixture of at least one selected from a group consisting of polyvinyl pyrrolidone, polyvinyl alcohol, starch and polyvinyl acetate and at least one selected from a group consisting of styrene-acryl polymer, polyacrylate, vinyl acetate-acryl polymer and polyurethane at a weight ratio of 1:2.5 to 1:3.5.

In an embodiment of the present disclosure, the polymer resin may be at least one of polyvinyl pyrrolidone and styrene-acryl polymer.

In an embodiment of the present disclosure, the polymer resin is a mixture of polyvinyl pyrrolidone and styrene-acryl polymer at a weight ratio of 1:2.5 to 1:3.5.

In an embodiment of the present disclosure, the paint composition may further comprise at least one selected from a group consisting of humectant, thickener and coloring agent.

In an embodiment of the present disclosure, the paint composition may further comprise at least one selected from a group consisting of 1 to 10 wt % of humectant, 0.2 to 2.0 wt % of thickener and 0.2 to 15 wt % of coloring agent based on a total weight of the composition.

In an embodiment of the present disclosure, the paint composition may further comprise at least one selected from a group consisting of defoaming agent, preservative and pH control agent.

In an embodiment of the present disclosure, the paint composition may have a viscosity of 40,000 to 100,000 cps.

In an embodiment of the present disclosure, the paint composition may form a three-dimensional film when dried at room temperature.

According to the paint composition of the present disclosure for forming a three-dimensional film, a three-dimensional effect may be given without a separate foaming process, and thereby inconvenience or risk factors caused by a separate heating process may be removed. Further, it may be applied to various materials as well as its texture is soft, elastic and lightweight, and thereby it may be used in various ways.

### BRIEF DESCRIPTION OF THE DRAWINGS

FIGS. 1 to 4 are images showing application examples of the paint composition according to an embodiment of the present disclosure.

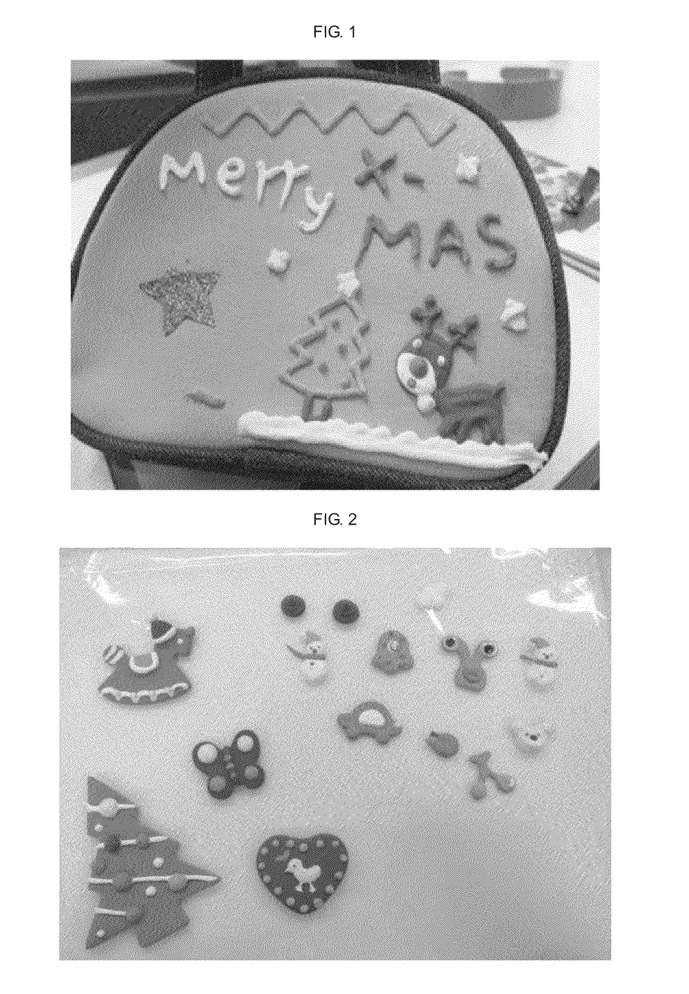

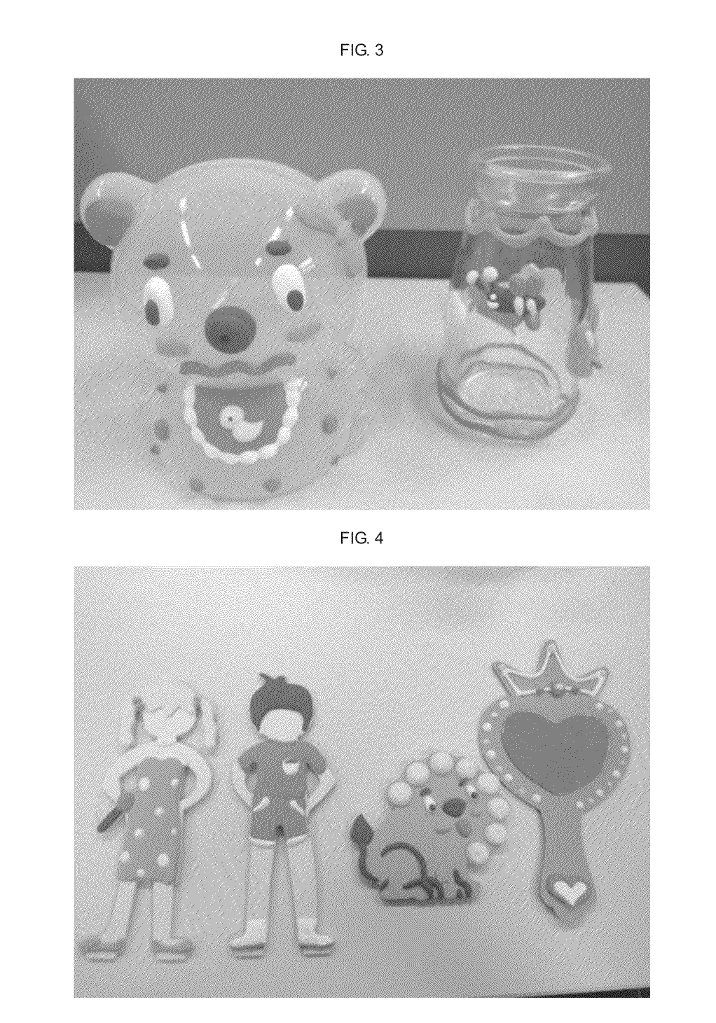

### DETAILED DESCRIPTION OF THE INVENTION

Exemplary embodiments now will be described more fully hereinafter with reference to the accompanying drawings, in which exemplary embodiments are shown.

The present disclosure provides a paint composition for forming a three-dimensional film comprising 1 to 10 wt % of a polymer hollow microsphere and 5 to 40 wt % of a polymer resin based on a total weight of the composition, wherein the polymer hollow microsphere has a density of 10 to 100 kg/m³ and a particle size of 10 to 200 μm.

The composition of the present disclosure, which comprises the polymer hollow microsphere having a density of 10 to 100 kg/m³ and a particle size of 10 to 200 μm, may form a three-dimensional film by only drying at room temperature without a separate foaming process.

In the present disclosure, the polymer hollow microsphere is gone through a foaming process, and may comprise a polymer hollow microsphere itself foamed in advance as an ingredient of the paint composition. The polymer hollow microsphere may play a role of a filler in the paint composition. The density (specific gravity) or the particle size of the polymer hollow microsphere may affect to the three-dimensional effect, the film texture, the usability, the production workability, the specific gravity of the compound and the like. Accordingly, the density and the particle size of the polymer hollow microsphere may be important.

The polymer hollow microsphere of the present disclosure may have a density of 10 to 100 kg/m³, specifically 10 to 35 kg/m³, more specifically 20 to 30 kg/m³. If the density of the polymer hollow microsphere is less than 10 kg/m³, the three-dimensional effect may become better, but there may be problems that the viscosity may become too high to use and the expressed form may be cracked after drying. But, if it excesses 100 kg/m³, the viscosity may become lower enough to use, but there may be a problem of poor three-dimensional effect.

Further, the polymer hollow microsphere of the present disclosure may be a particle size of 10 to 200 μm, specifically 10 to 100 μm, more specifically 20 to 60 μm. If the particle size of the polymer hollow microsphere is less than 10 μm, there may be a problem of too high viscosity to use, but when it excesses 200 μm, there may be a problem that the expressed form is looked rough.

In the present disclosure, the polymer hollow microsphere may be comprised in an amount of 1 to 10 wt %, specifically 1.5 to 3.0 wt %, based on a total weight of the composition. If the content is less than 1 wt %, the three-dimensional effect may be poor, and the film may become too hard to give soft feeling, but if it excesses 10 wt %, there may be problems that the viscosity may become too high to use, and there may be cracks on the film. Accordingly, when considering all of the three-dimensional effect, the film texture, the production workability, the ease of use and the like, the content may be 1 to 10 wt %.

In the present disclosure, the polymer hollow microsphere may comprise acryl polymer; and at least one selected from a group consisting of isobutane, isopentane and isooctane. Specifically, it may comprise acryl polymer and isobutane. In the present disclosure, the polymer hollow microsphere may be prepared by foaming microcapsules of a diameter of 10 μm, which is formed by an acryl polymer film of a thickness of 2 μm, and contains at least one selected from a group consisting of isobutane, isopentane and isooctane, to a diameter of 40 μm. After foaming, at least one gas selected from the group consisting of isobutane, isopentane and isooctane may be comprised in the microcapsule.

Further, the polymer hollow microsphere may be further mixed with at least one selected from a group consisting of silica, calcium carbonate and talc. In the present disclosure, the mixing may be simple mixing or coating.

Further, the paint composition of the present disclosure may comprise a polymer resin. In the present disclosure, the polymer resin may be any component keeping a shape of paint when paint for craft is applied, and maintaining adhesion with a material, without limitation. Specifically, it may be at least one selected from a group consisting of polyvinyl pyrrolidone, polyvinyl alcohol, starch, polyvinyl acetate, styrene-acryl polymer, polyacrylate, vinyl acetate-acryl polymer and polyurethane. More specifically, it may be at least one of polyvinyl pyrrolidone and styrene-acryl polymer.

Particularly, in the present disclosure, the polymer resin may be a mixture of at least one water soluble resin selected from the group consisting of polyvinyl pyrrolidone, polyvinyl alcohol, starch and polyvinyl acetate; and at least one selected from a group consisting of styrene-acryl polymer, polyacrylate, vinyl acetate-acryl polymer and polyurethane. If the water soluble resin is used alone, there may be a problem that water-resistance may become weak, thereby easily removed by water, and also there may be a problem that only some materials such as wood or paper may be used as a material to be expressed. When at least one selected from a group consisting of styrene-acryl polymer, polyacrylate, vinyl acetate-acryl polymer and polyurethane is used alone, there may be an advantage that the water resistance may be improved, and it may be used to various materials. However there may be a defect that the soft texture of the paint for craft may be reduced. Accordingly, it may be important to manufacture the paint composition by optimizing the composition of the polymer resin so as to be used to various materials and also give soft texture.

In order to make the paint composition of the present disclosure be used to various materials and give soft texture, the polymer resin of the present disclosure may be a mixture of at least one water soluble resin selected from the group consisting of polyvinyl pyrrolidone, polyvinyl alcohol, starch and polyvinyl acetate and at least one selected from a group consisting of styrene-acryl polymer, polyacrylate, vinyl acetate-acryl polymer and polyurethane at a weight ratio of 1:2.5 to 1:3.5. Specifically, the weight ratio may be about 1:2.75. Further, the polymer resin may be a mixture of polyvinyl pyrrolidone and styrene-acryl polymer at a weight ratio of 1:2.5 to 1:3.5.

In the present disclosure, the polymer resin may be comprised in an amount of 5 to 40 wt %, specifically 20 to 30 wt %, based on a total weight of the composition. If the total content of the polymer resin is less than 5 wt %, there may be problems of difficulty for keeping the shape, cracks formed after drying and long drying time. If the content excesses 40 wt %, there may be an advantage of shorter drying time, but there may be a problem to the production workability due to too high viscosity and a defect of difficulty to use when expressing the desired forms and letters. Particularly, when considering that the major user of the paint composition of the present disclosure is children, there may be a problem on using thereof due to too high viscosity.

In an aspect of the present disclosure, the paint composition may further comprise at least one selected from a group consisting of 1 to 10 wt % of humectant, 0.2 to 2.0 wt % of thickener and 0.2 to 15 wt % of coloring agent based on a total weight of the composition.

In the present disclosure, the humectant plays a role of preventing cracks on a film and making the film texture soft, and helps to keep physical properties for a long time through moisturizing function. In the present disclosure, the humectant is not particularly limited, but it may be at least one selected from a group consisting of glycerin, propylene glycol, butylene glycol, polyethylene glycol and sorbitol. If the amount of the humectant is less than 1 wt %, the film may be cracked and the soft feeling may become poor. But if it excesses 10 wt %, the drying time may become longer and there may be stickiness on the film. Accordingly, the amount of the humectant, which may secure the optimum physical properties, may be 1 to 10 wt %, specifically 1 to 5 wt %.

In the present disclosure, the thickener plays a role of keeping the form expressed by the paint on a material, so as to secure the three-dimensional effect. In the present disclosure, the thickener may be any material leading to have thixotropy while maintaining proper viscosity (40,000 to 100,000 cps) without particular limitation. And it may be at least one selected from a group consisting of polyacrylic acid and its salts, cellulose derivatives, gums, urethane thickener, and inorganic compound thickener. If the amount of the thickener is less than 0.2 wt %, it may be difficult to form the three-dimensional effect and keep the form to be expressed. But if it excesses 2.0 wt %, the usability may be poor due to excessive viscosity. Accordingly, the amount of the thickener to secure the optimal physical properties may be 0.2 to 2.0 wt %, specifically 0.3 to 1.0 wt %.

Meanwhile, if the thickener has a character of newtonian flow, it may be difficult to form the form to be expressed with the three-dimensional effect. However the desired viscosity may be secured by using the thickener having thixotropy and a pH control agent. In the present disclosure, the pH control agent may be at least one of ammonia, triethanolamine (TEA), 2-amino-2-methyl-1-propanol (AMP).

In the present disclosure, the coloring agent may be general dye, pigment, colored polymer material or a mixture thereof, but not limited thereto. However, the dye, having better hydrophilicity than the pigment, may have an advantage of bring good transparency and intrinsic gloss of a resin. But there may be defects of weak water resistance, and reduced chemical durability such as heat resistance and light resistance. In the case of the pigment having better chemical durability such as heat resistance, water resistance and light resistance than the dye and lower chemical activity, it may has better chemical stability than the dye when mixed with other chemical materials. It may be properly selected and used with consideration that the influence of dispersion of the pigment to the product may be big, and chroma, transparency or the like may be lower than the dye. In the present disclosure, the coloring agent may be comprised in an amount of 0.2 to 15 wt %, based on a total weight of the composition, depending on color. Specifically, a photo luminescent pigment of 5 to 15 wt % and other dyes and pigments of 0.2 to 5 wt % may display effective color.

In addition, the paint composition of the present disclosure may further comprise at least one selected from a group consisting of defoaming agent, preservative and pH control agent in an amount of 0.1 to 3.0 wt %. The defoaming agent is not particularly limited, and it may be silicone defoaming agent or mineral oil, and the pH control agent may be at least one of ammonia, triethanolamine (TEA) and 2-amino-2-methyl-1-propanol (AMP) as mentioned above.

Further, the paint composition of the present disclosure may comprise water in an amount of 30 to 90 wt %, specifically 50 to 80 wt %, based on the total weight of the composition.

In the paint composition according to the present disclosure, viscosity may be 40,000 to 100,000 cps, specifically 60,000 to 80,000 cps. When the viscosity is within the above range, the form planned to express may be kept when expressing the paint. However, the viscosity is less than 40,000 cps, the form may not be kept well when expressing the paint, and when it excesses 100,000 cps, it may be hard to use.

The paint composition according to the present disclosure may form a film having a three-dimensional effect when dried at room temperature. That is, while the conventional paint composition needs to be gone through a foaming process such as heating after the expression to be foamed to have a three-dimensional effect, the paint composition of the present disclosure does not need an additional foaming process, and it may accomplish the three-dimensional effect by only drying at room temperature. As used herein, “room temperature” refers to 20 to 30° C. The paint composition of the present disclosure is dried while moisture inside of the composition is vaporized, and the drying time may vary depending on the thickness or the area of the expressed film, but it may be completely dried within about 12 hours.

According to the paint composition of the present disclosure, there is no inconvenience of having to pass through a separate heating process because the three-dimensional effect may be given without a separate foaming process, the texture of the paint is also soft and elastic, and the usability is excellent due to lightweight. Accordingly, it may be used to various materials.

The examples will now be described. The following examples are for illustrative purposes only and not intended to limit the scope of the present disclosure.

### EXAMPLE 1

While stirring the ingredient number 1 of the following Table 1, the ingredient number 2 is added thereto followed by stirring until the ingredient number 2 is completely dissolved. Then, while stirring the resulting mixture at high speed, the ingredient number 3 is slowly added thereto, and stirred at high speed until the resulting liquid becomes transparent due to increased viscosity. Then, the ingredients numbers 4-9 are sequentially added to the thickened liquid followed by stirring until the liquid becomes homogeneous. The ingredient number 10 is added to the mixture followed by stirring until the mixture becomes homogeneous, so as to obtain a paint composition. As a polymer hollow microsphere, Expancel® Microsphere, which is a foamed material having a particle size of about 40 μm and a density of 25 kg/m³, is purchased from AkzoNobel. The ingredient number 4 is used as an aqueous solution state by dissolving the following amount of the material. The ingredient number 5 is represented by a pure resin content, and used as an emulsion resin containing the following amount of the material and 45% of water (solid content: 55%).

TABLE 1

| Number | Ingredient | wt % |
|---|---|---|
| 1 | Water | 68.5788 |
| 2 | Thickener (Polyacrylic acid) | 0.4 |
| 3 | pH control agent (TEA) | 0.52 |
| 4 | Water soluble polymer polyvinyl pyrrolidone | 6 |
| 5 | Styrene-acryl polymer | 16.5 |
| 6 | Humectant (Glycerin) | 5 |
| 7 | Defoaming agent (Mineral oil) | 0.5 |
| 8 | Preservative (5-chloro-2-methyl-4-isothiazolin- | 0.0012 |
| | 3-one, 2-methyl-2H-isothiazolin-3-one) | |
| 9 | Coloring agent (Pigment) | 0.5 |
| 10 | Polymer hollow microsphere (40 μm, 25 kg/m³) | 2 |

### EXAMPLE 2

While stirring the ingredient number 1 of the following Table 1, the ingredient number 2 is added thereto followed by stirring until the ingredient number 2 is completely dissolved. Then, while stirring the resulting mixture at high speed, the ingredient number 3 is slowly added thereto, and stirred at high speed until the resulting liquid becomes transparent due to increased viscosity. Then, the ingredients numbers 4-8 are sequentially added to the thickened liquid followed by stirring until the liquid becomes homogeneous. The ingredient number 9 is added to the mixture followed by stirring until the mixture becomes homogeneous, so as to obtain a paint composition.

TABLE 2

| Number | Ingredient | wt % |
|---|---|---|
| 1 | Water | 76.0788 |
| 2 | Thickener (Polyacrylic acid) | 0.4 |
| 3 | pH control agent (TEA) | 0.52 |
| 4 | Water soluble polymer polyvinyl pyrrolidone | 15 |
| 5 | Humectant (Glycerin) | 5 |
| 6 | Defoaming agent (Mineral oil) | 0.5 |
| 7 | Preservative (5-chloro-2-methyl-4-isothiazolin- | 0.0012 |
| | 3-one, 2-methyl-2H-isothiazolin-3-one) | |
| 8 | Coloring agent (Pigment) | 0.5 |
| 9 | Polymer hollow microsphere (40 μm, 25 kg/m³) | 2 |

### EXAMPLE 3

Each ingredient is stirred by the same method with the method of Example 2, so as to obtain a paint composition.

TABLE 3

| Number | ingredient | wt % |
|---|---|---|
| 1 | Water | 63.5788 |
| 2 | Thickener (Polyacrylic acid) | 0.4 |
| 3 | pH control agent (TEA) | 0.52 |
| 4 | Styrene-acryl polymer | 27.5 |
| 5 | Humectant (Glycerin) | 5 |
| 6 | Defoaming agent (Mineral oil) | 0.5 |
| 7 | Preservative (5-chloro-2-methyl-4-isothiazolin- | 0.0012 |
| | 3-one, 2-methyl-2H-isothiazolin-3-one) | |
| 8 | Coloring agent (Pigment) | 0.5 |
| 9 | Polymer hollow microsphere (40 μm, 25 kg/m³) | 2 |

### EXAMPLE 4

Each ingredient is stirred by the same method with the method of Example 1, so as to obtain a paint composition.

TABLE 4

| Number | Ingredient | wt % |
|---|---|---|
| 1 | Water | 68.5788 |
| 2 | Thickener (Polyacrylic acid) | 0.4 |
| 3 | pH control agent (TEA) | 0.52 |
| 4 | Water soluble polymer polyvinyl pyrrolidone | 6 |
| 5 | Styrene-acryl polymer | 16.5 |
| 6 | Humectant (Glycerin) | 10 |
| 7 | Defoaming agent (Mineral oil) | 0.5 |
| 8 | Preservative (5-chloro-2-methyl-4-isothiazolin- | 0.0012 |
| | 3-one, 2-methyl-2H-isothiazolin-3-one) | |
| 9 | Coloring agent (Pigment) | 0.5 |
| 10 | Polymer hollow microsphere (40 μm, 25 kg/m³) | 2 |

### EXAMPLE 5

Each ingredient is stirred by the same method with the method of Example 1, so as to obtain a paint composition.

TABLE 5

| Number | Ingredient | wt % |
|---|---|---|
| 1 | Water | 68.5788 |
| 2 | Thickener (Polyacrylic acid) | 0.4 |
| 3 | pH control agent (TEA) | 0.52 |
| 4 | Water soluble polymer polyvinyl pyrrolidone | 6 |
| 5 | Styrene-acryl polymer | 16.5 |
| 6 | Humectant (Glycerin) | 5 |
| 7 | Defoaming agent (Mineral oil) | 0.5 |
| 8 | Preservative (5-chloro-2-methyl-4-isothiazolin- | 0.0012 |
| | 3-one, 2-methyl-2H-isothiazolin-3-one) | |
| 9 | Coloring agent (Pigment) | 0.5 |
| 10 | Polymer hollow microsphere (40 μm, 25 kg/m³) | 1 |

### EXAMPLE 6

Each ingredient is stirred by the same method with the method of Example 1, so as to obtain a paint composition.

TABLE 6

| Number | Ingredient | wt % |
|---|---|---|
| 1 | Water | 68.5788 |
| 2 | Thickener (Polyacrylic acid) | 0.4 |
| 3 | pH control agent (TEA) | 0.52 |
| 4 | Water soluble polymer polyvinyl pyrrolidone | 6 |
| 5 | Styrene-acryl polymer (Solid: 55%) | 16.5 |
| 6 | Humectant (Glycerin) | 5 |
| 7 | Defoaming agent (Mineral oil) | 0.5 |
| 8 | Preservative (5-chloro-2-methyl-4-isothiazolin- | 0.0012 |
| | 3-one, 2-methyl-2H-isothiazolin-3-one) | |
| 9 | Coloring agent (Pigment) | 0.5 |
| 10 | Polymer hollow microsphere (20 μm, 60 kg/m³) | 2 |

### COMPARATIVE EXAMPLE 1

The ingredients numbers 1-6 of the following Table 7 are sequentially added, and stirred homogeneously. The ingredient number 7 is added thereto, and the ingredient number 8 is slowly added thereto to increase viscosity followed by stirring until the liquid becomes homogeneous, so as to obtain a paint composition. A copolymer encapsulating a foaming agent having a particle size of about 10-12 μm and a density of 900 kg/m³, is purchased from AkzoNobel. The copolymer encapsulating a foaming agent is a material, which is not foamed but is foamed when heating. The ingredient number 1 is represented by a pure resin content, and used as an emulsion resin containing the following amount of the material and 45% of water (solid content: 55%).

TABLE 7

| Number | Ingredient | wt % |
|---|---|---|
| 1 | Acryl polymer | 53.2678 |
| 2 | Water | 41.781 |
| 3 | Humectant (Propylene glycol) | 1.0 |
| 4 | Defoaming agent (Mineral oil) | 0.3 |
| 5 | Preservative (5-chloro-2-methyl-4-isothiazolin- | 0.0012 |
| | 3-one, 2-methyl-2H-isothiazolin-3-one) | |
| 6 | Coloring agent (Pigment) | 0.5 |
| 7 | Copolymer encapsulating a foaming agent | 2.0 |
| 8 | Thickener (Polyacrylic acid, 30%) | 0.9 |
| 9 | pH control agent (Ammonia) | 0.25 |

### COMPARATIVE EXAMPLE 2

Each ingredient is stirred by the same method with the method of Example 1, so as to obtain a paint composition, except for using a polymer hollow microsphere having a particle size of 40 μm and a density of 5 kg/m³ instead of the polymer hollow microsphere of Example 1.

TABLE 8

| Number | Ingredient | wt % |
|---|---|---|
| 1 | Water | 68.5788 |
| 2 | Thickener (Polyacrylic acid) | 0.4 |
| 3 | pH control agent (TEA) | 0.52 |
| 4 | Water soluble polymer polyvinyl pyrrolidone | 6 |
| 5 | Styrene-acryl polymer (Solid: 55%) | 16.5 |
| 6 | Humectant (Glycerin) | 5 |
| 7 | Defoaming agent (Mineral oil) | 0.5 |
| 8 | Preservative (5-chloro-2-methyl-4-isothiazolin- | 0.0012 |
| | 3-one, 2-methyl-2H-isothiazolin-3-one) | |
| 9 | Coloring agent (Pigment) | 0.5 |
| 10 | Polymer hollow microsphere (40 μm, 5 kg/m³) | 2 |

### COMPARATIVE EXAMPLE 3

Each ingredient is stirred by the same method with the method of Example 1, so as to obtain a paint composition, except for using a polymer hollow microsphere having a particle size of 40 μm and a density of 150 kg/m³ instead of the polymer hollow microsphere of Example 1.

TABLE 9

| Number | Ingredient | wt % |
|---|---|---|
| 1 | Water | 68.5788 |
| 2 | Thickener (Polyacrylic acid) | 0.4 |
| 3 | pH control agent (TEA) | 0.52 |
| 4 | Water soluble polymer polyvinyl pyrrolidone | 6 |
| 5 | Styrene-acryl polymer (Solid: 55%) | 16.5 |
| 6 | Humectant (Glycerin) | 5 |
| 7 | Defoaming agent (Mineral oil) | 0.5 |
| 8 | Preservative (5-chloro-2-methyl-4-isothiazolin- | 0.0012 |
| | 3-one, 2-methyl-2H-isothiazolin-3-one) | |
| 9 | Coloring agent (Pigment) | 0.5 |
| 10 | Polymer hollow microsphere (40 μm, 150 kg/m³) | 2 |

### COMPARATIVE EXAMPLE 4

Each ingredient is stirred by the same method with the method of Example 1, so as to obtain a paint composition, except for using a polymer hollow microsphere having a particle size of 5 μm and a density of 25 kg/m³ instead of the polymer hollow microsphere of Example 1.

TABLE 10

| Number | Ingredient | wt % |
|---|---|---|
| 1 | Water | 68.5788 |
| 2 | Thickener (Polyacrylic acid) | 0.4 |
| 3 | pH control agent (TEA) | 0.52 |
| 4 | Water soluble polymer polyvinyl pyrrolidone | 6 |
| 5 | Styrene-acryl polymer (Solid: 55%) | 16.5 |
| 6 | Humectant (Glycerin) | 5 |
| 7 | Defoaming agent (Mineral oil) | 0.5 |
| 8 | Preservative (5-chloro-2-methyl-4-isothiazolin- | 0.0012 |
| | 3-one, 2-methyl-2H-isothiazolin-3-one) | |
| 9 | Coloring agent (Pigment) | 0.5 |
| 10 | Polymer hollow microsphere (5 μm, 25 kg/m³) | 2 |

### COMPARATIVE EXAMPLE 5

Each ingredient is stirred by the same method with the method of Example 1, so as to obtain a paint composition, except for using a polymer hollow microsphere having a particle size of 300 μm and a density of 25 kg/m³ instead of the polymer hollow microsphere of Example 1.

TABLE 11

| Number | Ingredient | wt % |
|---|---|---|
| 1 | Water | 68.5788 |
| 2 | Thickener (Polyacrylic acid) | 0.4 |
| 3 | pH control agent (TEA) | 0.52 |
| 4 | Water soluble polymer polyvinyl pyrrolidone | 6 |
| 5 | Styrene-acryl polymer (Solid: 55%) | 16.5 |
| 6 | Humectant (Glycerin) | 5 |
| 7 | Defoaming agent (Mineral oil) | 0.5 |
| 8 | Preservative (5-chloro-2-methyl-4-isothiazolin- | 0.0012 |
| | 3-one, 2-methyl-2H-isothiazolin-3-one) | |
| 9 | Coloring agent (Pigment) | 0.5 |
| 10 | Polymer hollow microsphere (300 μm, 25 kg/m³) | 2 |

### TEST EXAMPLE 1

Physical properties of the paint compositions of Examples 1 to 6 and Comparative Examples 1 to 5 are measured as follows. The paint composition is expressed on a paper and a textile, and three-dimensional effect, usability, water resistance, film texture, drying time and film crack are measured, respectively. Drying is conducted at room temperature. Specifically, the three-dimensional effect is measured by observing a degree of protruding of the film from the material, and the usability is represented by a degree of ease when the paint composition is released from a paint composition container. The water resistance is measured by checking a degree of smear, when rubbed with a finger after dropping water by a pipette on the dried film, with the naked eye. The film texture is measured by sensually checking a degree of hard or soft when pressing the dried film, and the soft film is regarded as a good quality. The drying time is a time measured until the released paint composition on the film is completely dried, and the drying time within 15 hours, 15 hours to 24 hours, and more than 24 hours are regarded as excellent, normal and bad, respectively. The film crack is measured by checking a size of the crack formed on the dried film with the naked eye.

TABLE 12

| | Three- | | | | | | |
|---|---|---|---|---|---|---|---|
| | dimensional | | Water- | Film | Drying | Film | Foaming |
| | effect | Usability | resistance | texture | time | crack | process |
| EX. 1 | Very | Excellent | Excellent | Very | Excellent | Excellent | Unnecessary |
| | excellent | | | excellent | | | |
| EX. 2 | Very | Bad | Bad | Very | Excellent | Excellent | Unnecessary |
| | excellent | | | excellent | | | |
| EX. 3 | Excellent | Excellent | Very | Normal | Excellent | Excellent | Unnecessary |
| | | | excellent | | | | |
| EX. 4 | Excellent | Excellent | Normal | Very | Bad | Excellent | Unnecessary |
| | | | | excellent | | | |
| EX. 5 | Normal | Very | Excellent | Normal | Normal | Excellent | Unnecessary |
| | | excellent | | | | | |
| EX. 6 | Normal | Very | Excellent | Normal | Normal | Excellent | Unnecessary |
| | | excellent | | | | | |
| Comp. | Normal | Bad | Excellent | Normal | Normal | Excellent | Necessary |
| EX. 1 | | | | | | | |
| Comp. | Excellent | Bad | Normal | Excellent | Excellent | Bad | Unnecessary |
| EX. 2 | | | | | | | |
| Comp. | Normal | Excellent | Normal | Bad | Normal | Excellent | Unnecessary |
| EX. 3 | | | | | | | |
| Comp. | Excellent | Bad | Excellent | Very | Normal | Excellent | Unnecessary |
| EX. 4 | | | | excellent | | | |
| Comp. | Normal | Excellent | Excellent | Bad | Normal | Excellent | Unnecessary |
| EX. 5 | | | | | | | |

What is claimed is:

1. A paint composition for forming a three-dimensional film comprising 1 to 10 wt % of a polymer hollow microsphere and 5 to 40 wt % of a polymer resin based on a total weight of the composition, wherein the polymer hollow microsphere has a density of 10 to 100 kg/m³ and a particle size of 10 to 200 μm.

2. The paint composition for forming a three-dimensional film according to claim 1, wherein the polymer hollow microsphere is produced by a foaming process.

3. The paint composition for forming a three-dimensional film according to claim 1, wherein the polymer hollow microsphere comprises acryl polymer and at least one selected from a group consisting of isobutane, isopentane and isooctane.

4. The paint composition for forming a three-dimensional film according to claim 1, wherein the polymer hollow microsphere is mixed with at least one selected from a group consisting of silica, calcium carbonate and talc.

5. The paint composition for forming a three-dimensional film according to claim 1, wherein the polymer resin is at least one selected from a group consisting of polyvinyl pyrrolidone, polyvinyl alcohol, starch, polyvinyl acetate, styrene-acryl polymer, polyacrylate, vinyl acetate-acryl polymer and polyurethane.

6. The paint composition for forming a three-dimensional film according to claim 1, wherein the polymer resin is a mixture of at least one selected from a group consisting of polyvinyl pyrrolidone, polyvinyl alcohol, starch and polyvinyl acetate and at least one selected from a group consisting of styrene-acryl polymer, polyacrylate, vinyl acetate-acryl polymer and polyurethane at a weight ratio of 1:2.5 to 1:3.5.

7. The paint composition for forming a three-dimensional film according to claim 1, wherein the polymer resin is at least one of polyvinyl pyrrolidone and styrene-acryl polymer.

8. The paint composition for forming a three-dimensional film according to claim 1, wherein the polymer resin is a mixture of polyvinyl pyrrolidone and styrene-acryl polymer at a weight ratio of 1:2.5 to 1:3.5.

9. The paint composition for forming a three-dimensional film according to claim 1, which further comprises at least one selected from a group consisting of humectant, thickener and coloring agent.

10. The paint composition for forming a three-dimensional film according to claim 1, which further comprises at least one selected from a group consisting of 1 to 10 wt % of humectant, 0.2 to 2.0 wt % of thickener and 0.2 to 15 wt % of coloring agent based on a total weight of the composition.

11. The paint composition for forming a three-dimensional film according to claim 9, which further comprises at least one selected from a group consisting of defoaming agent, preservative and pH control agent.

12. The paint composition for forming a three-dimensional film according to claim 1, which has a viscosity of 40,000 to 100,000 cps.

13. The paint composition for forming a three-dimensional film according to claim 1, which forms a three-dimensional film when dried at room temperature.
